(19) United States
(12) Patent Application Publication
(10) Pub. No.: US 2009/0291419 A1
(43) Pub. Date: Nov. 26, 2009

(54) System of sound representaion and pronunciation techniques for english and other european languages

(76) Inventors: Kazuaki Uekawa, Washington, DC (US); Jeana Lynn George, Washington, DC (US)

Correspondence Address: Kazuaki Uekawa, P O Box 3703, Washington, DC, 20027, US

(21) Appl. No.: 11/989,668

(22) PCT Filed: Aug. 1, 2006
(86) PCT No.: PCT/US2006/029791

§ 371 Date: Jan. 28, 2008

Related U.S. Application Data
(60) Provisional application No. 60/704,284, filed on Aug. 1, 2005.

(51) Int. Cl. G09B 19/06

(52) U.S. Cl. 434/185

(57) ABSTRACT

We invented (a) a teaching method of European language pronunciation (the English language included), as well as (2) a system of representation of European language sounds. We discovered that European language speakers resonate sound primarily in the throat, while Asian speakers do so primarily in the mouth (THE THROAT LAW) and based on this discovery we invented a way to condition one's throat to pronounce like native speakers of European languages. We also invented a way to represent how to read syllables and how to connect syllables, capitalizing on our discovery of how native speakers read them (THE 3-BEAT LAW). Our system of representation can be used to build a reading assistance devise, such as electronic dictionary.

### TECHNICAL FIELD

This invention relates to the field of linguistics/phonology, as well as to the field of assisting language learners to master pronunciation and listening comprehension of European languages, including English, French, and Spanish. The invention also is related to the field of machine-based sound production. The invention includes a representation system of European language sounds that can be used in electronic dictionary type of gadgets.

### BACKGROUND ART

Definition notes: In this application, “European language” refers to Western languages, such as English, French, and Spanish.

Especially when audiences/learners are Asians and the target languages are European, all prior arts failed. This is because past inventors did not know about our discovery. Comparing Japanese and English, we discovered that European language speakers and Asian language speakers use the throat in very different ways. European language speakers resonate sounds primarily in the throat, while speakers of many Asian languages, most notably Japanese, Korean, and Chinese, resonate sounds mostly in the mouth. Asian people might have noticed, while watching western actors and actresses in movies, that the quality of westerners' voice is different from Asians'; however, many people might thought of it as a biological difference related to the size of the throat. Nobody knew, before us, that the reason why Japanese people speak English with heavy accent was precisely because of this difference in how Asians and Westerners use the throat.

Most prior arts failed because they blindly followed ideas of language scholars. Linguists, or phonologists in particular, considered sounds primarily arise as a result of fixed tongue position, the shape of the mouth, and the lips. These movements, according to our discovery, are (1) only for small adjustment of sound, (2) superficial ways of expression to show emotion (i.e., facial expressions/gestures), or (3) native speakers' mere attempts to exaggerate.

The most famous prior art in this context is International Phonetic Association's vowel map. This map can be found at http://www.arts.gla.ac.uk/IPA/vowels.html (or by searching for a keyword, “Reproduction of The International Phonetic Alphabet” on the Internet and click on “vowel.”). This graphic shows the picture of a mouth and places vowel symbols at the positions that linguists claim the tongue should be when the vowels are said. Also the graphic teaches how widely you must open the mouth. For example, “i” is said to be a FRONT-CLOSE vowel, which means that the tongue to be at the FRONT position of the mouth, while the mouth should be close to being CLOSED. A vowel “a” is classified as a BACK-OPEN vowel, meaning the tongue should be at the back of the mouth and the mouth itself has to be widely open.

This prior art contradicts reality. The tongue position or the mouth shape are not important in the production of vowel sounds. For example, in speaking English, native speakers can place their tongue at any positions and can still say any vowels. They can say any vowels with any shape of the mouth, regardless of how wide you open the mouth. This is because vowels are produced around the vocal cord in the throat and it has nothing to do lips, the tongue, or the general shape of the mouth. There may be natural positions of the tongue that is most comfortable for native speakers; however, such tongue position, at least in English, is a flat tongue position. See a video clip where a speaker pronounces different vowels with his tongue completely out of his mouth, but still succeeds at producing correct sounds. This proves that the tongue position or the mouth shape are not important for the production of vowel sounds.
<Video Clip 1 at http://www.estat.us/patent The password is hoerumethod.>

Phonologists' description of consonants also had unfortunate consequences for Asian learners. In their literature, as well as in the curricula that utilizes the phonogists' tradition, scholars describe exaggerated forms of pronunciation instead of natural pronunciation. For example, scholars claim W is pronounced with rounded lips or R is pronounced with curled tongue; however, these contradict reality. Native speakers of English can pronounce most consonants even with the tongue sticking out of the mouth or without moving the lips a lot. See a video clip in which this is demonstrated:
<Video Clip 2 at http://www.estat.us/patent The password is hoerumethod.>

As long as sounds are resonated in the throat, the role of the mouth is minimum in European languages.

Although scholars stress the importance of mouth positions, most sounds in English exist in Asian languages. For example, a majority of Japanese sound are identical in English. If only resonated in the throat, Japanese sounds sound exactly the same as English sounds. Thus, there is no need to study the exact position of tongues and the lips.

Some European consonants involve the movements of the tongues that non-native speakers are not very familiar with. The TH sound in English (e.g., “Thanks”) requires that the tongue be placed in between the front teeth and the tongue; however, failing to place the tongue at the exact position IN NOT the reason why non-natives cannot pronounce it correctly. A failure occurs because non-natives, particularly Japanese, Koreans, and Chinese, resonate sounds in the mouth instead of the throat.

Prior arts based on the phonological tradition had negative consequences. It teaches trivial things without achieving results. Inouye et al. (U.S. Pat. No. 5,286,205) is a good example. This prior art teaches learners the shape of the mouth associated with pronunciations. For example, to learn how to say W, learners listen to the sound, while seeing the picture of the rounded shape. Because the shape of the mouth is a trivial issue in the malting of sounds, the method doesn't achieve its goal. Learners may become somewhat accidentally good at approximating native sounds because they end up spending a lot of time studying English; however, this prior art does not help learners to produce the same native sounds.

Our system of learning is not only better than prior arts, but it simply is the only way to improve. This is because our method teaches what native speakers are doing. We only mentioned the use of the throat so far, but we also discovered a way to teach how non-native speakers can read syllables, so they can achieve the same natural flow as native speakers. All prior arts might have helped non-native learners approximate sounds, but approximation is only approximation. Our invention is based on the true way native speakers of the English language speak and therefore our method can effectively help learners achieve native speaker's pronunciation level and enhances listening comprehension ability.

### DISCLOSURE of INVENTION

We invented (a) a teaching method of European language pronunciation, as well as (2) a system of representation of European language sounds. The general method is referred to as the HOERU (howl) method. We discovered that European language speakers resonate sound primarily in the throat, while Asian speakers do so primarily in the mouth (THE THROAT LAW) and based on this discovery we invented a way to condition one's throat to start sounding like native speakers of European languages. We also invented a way to represent how to read syllables and how to connect syllables, capitalizing on our discovery of how native speakers read them (THE 3-BEAT LAW).

We think of our invention first as a teaching method. We also think of our invention as a system of representation of European sounds. By the latter we mean a system of phonetic symbols that can represent how a native speaker reads words, phrases, and sentences. This can be utilized by a digital dictionary type of devises or reading assistance devises, so users can type in words and phrases (INPUT) and receive visual and audio instruction on how to read them (OUTPUT).

Our discovery and invention were born in the context of teaching English to Japanese people. However, our invention is also useful for every language group to learn any European languages. For example, Koreans and Chinese can use our invention to learn English or other European languages. Europeans also benefit when learning other European languages that are not their first languages.

### BRIEF DESCRIPTION OF DRAWINGS

FIG. 1 shows that Asian language speakers resonate sounds in the mouth (#101) and European resonate sounds in the throat (#102).

FIG. 2 shows a throat diagram indicating the yearn area (#103), the vocal cord (#104), and the burp area (#105).

FIG. 3 shows how Japanese pronounce MA-MI-MU-ME-MO when they speak in Japanese. Dark areas are the parts that are pronounced. They cannot separate a vowel from a consonant. Also their sounds are cut short at the beginning and at the end.

FIG. 4 shows how native speakers of English pronounce the same MA MI MU ME MO. They separate each sound clearly and each sound has a full life cycle. Unlike Japanese sounds, the beginning and the end of each individual sound is not cut.

FIG. 5 shows that the K (the last sound of the first syllable; #106) is called “a swing consonant” and the N (the first sound of the second syllable; #107) is called “a follow-through consonant.”

FIG. 6 shows how two prior arts and our HOERU symbols compare in representing an example word, “summer.” Our symbols capture not only the sound, but also the rhythm with which to read this word correctly. The prior arts would only produce a robot-like reading of the word.

FIG. 7 shows the four phrases of our teaching method.

FIG. 8 shows where a throat break is activated when Japanese people speak. This area becomes tense to add choppy quality to the sounds. This area also closes in extreme cases, so sounds are cut very short.

FIG. 9 are two examples of the throat diagram indicating which sounds should be resonated at which area of the throat (yarn area or burp area). On the right diagram, half of the circle is darkened, which indicates that to pronounce R, a learn needs to use a very deep area of the throat.

FIG. 10, FIG. 11, and FIG. 12 are the charts of our HOERU symbols with example words. Learners can learn to obtain correct pronunciation by listening to the sounds both across the rows and the columns and by repeating after the sounds.

FIG. 13 shows how an expression “You will be fine” is represented by a prior art (International Phonetic Alphabet) and our HOERU symbols. Only our representation facilitates a learner to read the sentence with correct pronunciation and with correct rhythm. Prior arts would make the learners sound like robots.

FIG. 14 shows how a reading assistance devise processes a user input (A user type in words) and outputs a sound and HOERU symbols (The user hear the sound and read the HOERU symbols).

FIG. 15 shows an another possibility of how a reading assistance devise processes a user input (A user type in HOERU symbols) and outputs a sound and HOERU symbols (users hear the sound and read the HOERU symbols with some transformations applied).

### MODES FOR CARRYING OUT THE INVENTION

Two universal laws we discovered about European and Asian languages are the bases of our invention.

### Discovery

### Speaking Form the Throat

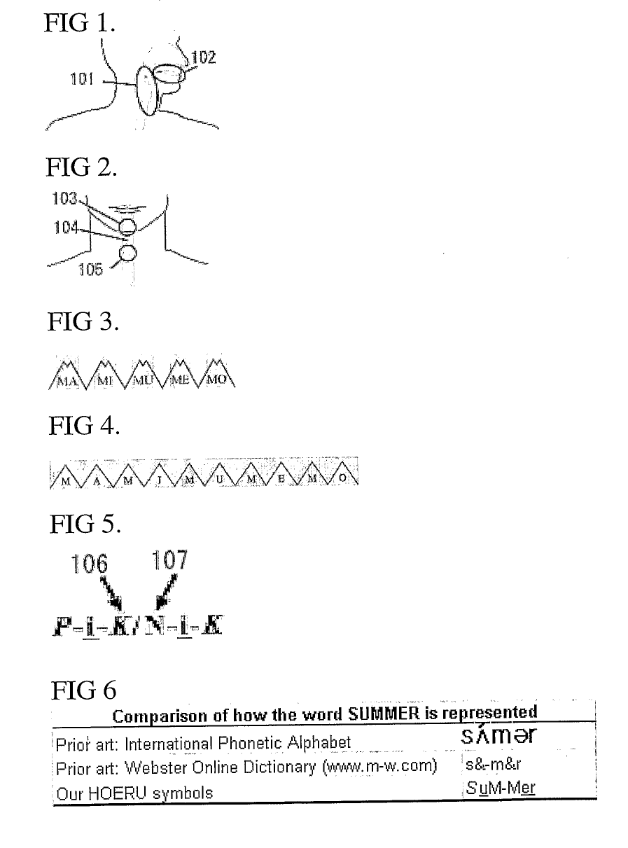

To reiterate, we discovered that European language users resonate most of sounds in the throat, while Asian language users, such as Japanese, Koreans, and Chinese, resonate most of sounds in the mouth. FIG. 1 shows the two different areas of the throat that Europeans and Asians use for sound resonation. Europeans resonate sounds in the throat (#101) and Asians resonate them in the mouth (#102).

### <FIG. 1>

This is why speakers of many Asian languages cannot imitate European sounds well. To state this slightly differently, the reason why Asians cannot repeat what they hear (i.e., listen-and-repeat method fails) is because they rely on the mouth for sound resonation. To correct this, they should use the throat in the way we describe later. They cam easily produce the same sounds as native speakers, if they use our method.

According to our discovery, Europeans rely on two throat locations to achieve sound resonation, creating distinct characteristic of each individual sound. In FIG. 2, the yawn area (#103) refers to the area above the vocal cord (#104), while the burp area (#105) refers to the area below the vocal cord. We use the terminology of the yawn and burp areas because these correspond to the muscles that move when a person yawns or burps—regardless of what languages the person speaks. Because yawning and burping are such fundamental human actions, anyone can understand where these locations are.

### <FIG. 2>

Most of French sounds are resonated at the burp area, while most of Spanish sounds are resonated at the yawn areas. English uses both rather evenly, though this also depends on a regional variation of English. To achieve deep resonation in the throat, the throat must be completely relaxed. Only the relaxed throat can achieve deep resonation, necessary to produce European sounds.

Asian languages, such as Japanese, Korean, and Chinese, rely on the mouth to achieve sound resonation. Japanese throat tenses up (or even closes to block the air/sound flow) for producing a majority of sounds; hence, it cannot achieve deep, 3-dimentional sounds, the sound elements without which one cannot imitate European sounds well. Mouth is a restricted area surrounded by hard bones; hence, it is not flexible enough to produce a large variety of sounds. In fact, if one uses the throat like Westerners, one's ability to imitate any sounds (e.g., animal voice, sounds of gun fires, etc.) improves.

To understand why the throat of Japanese speakers dot not stay relaxed, we need to understand that in Japanese the duration of sounds affects meaning. For example, OJISAN (uncle) and OJI˜SAN (grand father) are different words. (Compare this to English; “Hello” and “He˜llo˜” mean the same. The length of a sound does not affect its literal meaning in English.) There are a lot more short sounds in Japanese than long sounds. This means that the throat has to make sure a majority of sounds are short, so they are differentiated from a minority of long sounds. To differentiate the sound length, Japanese throat stay tense and cuts sounds. As a result, the quality of Japanese sounds is choppy.

Compare this to European languages. Because the throat stays open and relaxed, individual sounds in European language have full life cycles with the beginning, the middle, and the end. In other words, each individual sound is not cut short in European languages. In FIGS. 3 and 4, we compare the sounds of “M-A-M-I-M-U-M-E-M-O,” said by Japanese speakers and by English speakers. The dark areas are the parts that are actually pronounced.

FIG. 3 shows that (a) Japanese cannot completely separate each individual sound and that (b) for each pair of a vowel and a consonant, such as MA, the beginning and the end of the sounds are cut. In contrast, English sounds are not cut. Each sound has a full life cycle. It begins where a sound really begins and it ends when the sound really ends. Only when the throat is relaxed and resonated, sounds can achieve this type of full life cycle, necessary to achieve native-like pronunciation.

### <FIG. 3 and FIG. 4>

In other Asian languages, such as Chinese, duration does not affect meanings, but still the throat stays tense and each sound tends to be short. This may be partly because pitch affects meaning in many of Asian languages. This may necessitate the tightening of the throat, so pitch can be controlled rapidly. As a result of this tension, the throat cannot resonate well, making the mouth a primary location of resonation. Regardless of the reasons, it simply is a fact—Asians' throat is not as relaxed as Europeans when producing sounds and they rely heavily on the mouth to resonate sounds.

This difference is precisely why Japanese, for example, can only approximate European sounds and are never capable of producing the same native sounds. For example, L and R of English are difficult for Japanese learners of English. While even after many practices they will never produce the same sounds as native speakers. True American R must resonate deep in the neck (burp area), while L must resonate above the vocal cord (yawn area). Japanese throat is too tense during a sound production or is sometimes even closed immediately after the sounds are produced. Our teaching method (to be detailed later) helps Asian language speakers to use the throat in the same way as European language speakers. Our method finally makes it possible for Japanese to produce same native sounds. Other Asians, including Koreans and Chinese also benefit.

Europeans also benefit from our invention when they learn other European languages as foreign language. Although they already use the throat to speak their native language, they only know this subconsciously and they are not aware that they have to use two resonation areas selectively in other European languages. French speakers tend to imitate English sounds using only the burp area, as the latter is the area most commonly used for French sounds. Similarly, English speakers, not knowing that French sounds must be resonated in the burp area, speak French with English accent.

### Discovery

### 3-Beat

We also discovered how to read syllables and how to connect them to read like native speakers. We use an expression, “the rhythm of European languages is 3-beat.” In the discussion to follow, we use English mostly as an example language; however, all apply to other European languages. Also C represents a consonant and V represents a vowel.

3-beat refers to an already known structure of CVC that makes up basic sound units called syllables. In English, a syllable consists of three elements, a consonant (C), a vowel (V), and a consonant (C) and we read each syllable in the duration of one clap. The problem, however, is that the concept of syllable is difficult for Asian learners to understand. For Japanese, a syllable consists of CV or V; thus, they have difficulty understanding how to read CVC patterns that appear in European languages.

We discovered two things non-native speakers must do to read words and phrases in 3-beat and achieve native-like flow. The first is about how to read a syllable and the other is about how to connect syllables. Asians have a hard time understanding the concept of European syllables because they are not aware of these two things.

### First Point about 3-Beat

### How to Read Syllables

First, we discuss how we read syllables in European languages. A CVC cluster (consonant-vowel-consonant) is a basic design of a syllable. This is a known fact and we don't claim novelty on this rule.
3-beat rule 1 (CVC Rule): A basic sound unit in European languages is a syllable made up of C-V-C. This unit has to be read in the duration of one clap.

To follow this rule, a word “man” should be read in one clap. A word “picnic” should be read in two claps.

This rule, however, puzzles Asians whose language is not 3-beat. Learners quickly notice that there are a lot of words that do not follow a CVC construction. For example, “spring” is CCCVCC and “like” is CVVC. The underlined parts correspond to the successions of Cs or Vs. For our discussion we call these “group consonants” and “group vowels.”

Linguists tend to just describe such sequence of sounds without providing a helpful solution for non-native learners—as if they expect non-native learners to know how to read such a sequence. We provide a solution by taking advantage of the fact that native speakers read group consonants and group vowels as if they are one C or one V. In other words, CC or CCC should be read as if they were just one C. Likewise, VV should be read as if it were one V. One should read these group sounds as a sequence of sounds that are naturally and smoothly connected, so they sound just like one sound. Thus, we add a rule:
3-beat rule 2 (Group Rule): group consonants or group vowels should be treated as, respectively, one C and one V.

A conventional dictionary says a word “spring” has a CCCVCC structure. In our system, we treat the CC or CCC parts to be replaced by single Cs. Hence, spring now has one CVC set and thus one syllable word. And in reality, this is the way native speakers of English read group consonants as if they occupy one space for C. The same is true with succession of vowels. “Like” should be read as CVC instead of CVVC. Like any other syllables, these syllables must be read in the duration of one clap.

### Second Point about 3-Beat

### How to Connect Syllables

The second point is about how to connect syllables and read them naturally and smoothly like native speakers. To set terminologies, let us call a consonant that sits at the end of a syllable “a swing consonant.” The consonant that immediately follows it and thus sits at the beginning of a next syllable is called “a follow-through consonant.” Thus, in the following example, picnic, C is a swing consonant and N is a follow-through consonant.

Pic-nic C-V-C/C-V-C

For confirmation, see FIG. 5 where we graphically represent the same word. #106 indicates a swing consonant and #107 indicates a follow-through consonant.

### <FIG. 5>

Now we introduce a rule about how to reads these two types of consonants:
3-beat rule 3 (Swing and Follow-through Rule). A swing consonant is read up to a half of the sound and a follow-through consonant is read from a half point to the end.

When native speakers read smoothly and naturally, they read a swing consonant only to the mid-point of a sound and a follow-through consonant from the mid-point to the end. (Recall that, unlike Japanese sounds, European sounds are not cut at the beginning and at the end; hence, each individual sound has a whole life cycle (Review FIG. 4 to confirm this point), which is why there is a sense of a middle point.)

Swing and follow-through consonants are special in that they are halves of the whole sounds. It is not so much that native speakers are consciously trying to read only halves of the sounds. Rather, this occurs naturally when native speakers read syllables smoothly. In other words, this way of reading has to happen automatically by reading each syllable in the duration of a clap and connecting syllables smoothly.

The terms swing and follow-through come from baseball terminology. When an expert describes a batter's swing, the first half of a swing is called “swing” and the latter half of it is called “a follow-through.” We use this, so learners have this image of how swing and follow-through have to be said in succession without a stop.

The swing and follow-through rule, however, is not completely useful by itself. In English, in particular, there are many words that resist easy 3-beat reading in the eyes of non-native speakers. This is because spelling obscures how words and phrases should be read. For example, a word “Japan,” according to a prior art consists of CVCVC. This is not easy to break into sets of CVCs. (One C is missing to have complete sets of CVCs.)

We add a new rule here. We discovered that very often English spelling lacks consonants and thus we need to add the lacking consonants. We continue with an example word, “Japan.” If non-native learners of English try to break this word into a CVC structure, it is not clear where to cut the word into syllables. See an example below and confirm that the second syllable doesn't have a complete CVC structure.

### Japan CVC-VC

We provide a solution to this problem by adding a lacking consonant and express it in the following way.

jap-pan CVC-CVC

And this is the way native speakers of English read this word by repeating the consonant P twice.

Thus, we add a rule:
3-beat rule 4 (Copy Rule). when consonants are lacking to have complete CVC structures, consonants get copied from the nearby consonant.

The copy rule was simply hidden from our eyes because of irregularity in the spelling of English. Notice this also in words, such as “korea (Kor-rea),” “China (chin-na),” “event (ev-vent).” Even when the spelling explicitly expresses double consonants, however, linguists have failed to make note of them. For example, notice there are two Ms in SUMMER, two Ls in FALLEN, two Rs in BERRY.

Linguists have ignored this doubling of consonants in their famous phonetic alphabet utilized in many dictionaries and textbooks of the English language. FIG. 6 shows how a word “summer” is represented by two prior arts and our invention. Only our system make note of the fact that native speakers of European languages speak in 3-beat and consonants are doubled, Also recall that according 295 to Swing and follow-through rule, the swing consonant (P) should be read up to its mid-point and the Following through consonant (again P) should be read from its mid-point to the end. This adds a native-like flow to a speech. In contrast, prior arts cannot express these native qualities and would produce robot-like pronunciation.

### <FIG. 6>

As an exception to the Copy Rule, there are cases where consonants are copied even when no consonant seems missing on appearance. This occurs with words, such as abroad, or people, or English. In terms of spelling, all these words already have enough number of consonants to create perfect CVC clusters—without copying any consonants; however, still the doubling of consonants occurs, so native-like quality can be retained. For example, native speakers pronounce “abroad” as “ab-broad (notice the doubling of b)”, “people” as “peop-ple (notice the doubling of p)”, and “English” as “eng/glish.” These are the words that involve group consonants at the syllable-to-syllable connection points. Some group consonants are strongly tied, tending to stick with each other. For example, in “abroad,” we see a group consonant BR. When the word breaks into two syllables, it does not break into “ab-road.” Rather, it breaks into “ab-broad,’ so B and R are not separated. The same dynamic occurs with other words, such as people or English. We treat this as a special case that belongs to the copy rule.

We also discovered that the 3-beat principle apply not only to read a word but to read phrases and sentences. See examples in English and Spanish.

English: “He can” is read as “HIK-KaN”

Spanish: “Como estas?” is read as “KOM-MOW-WES-STAS?

Thus, we add a rule to accommodate this fact:
3-beat rule 5 (Phrase Rule). 3-beat applies not only to a word but also to phrases and sentences.

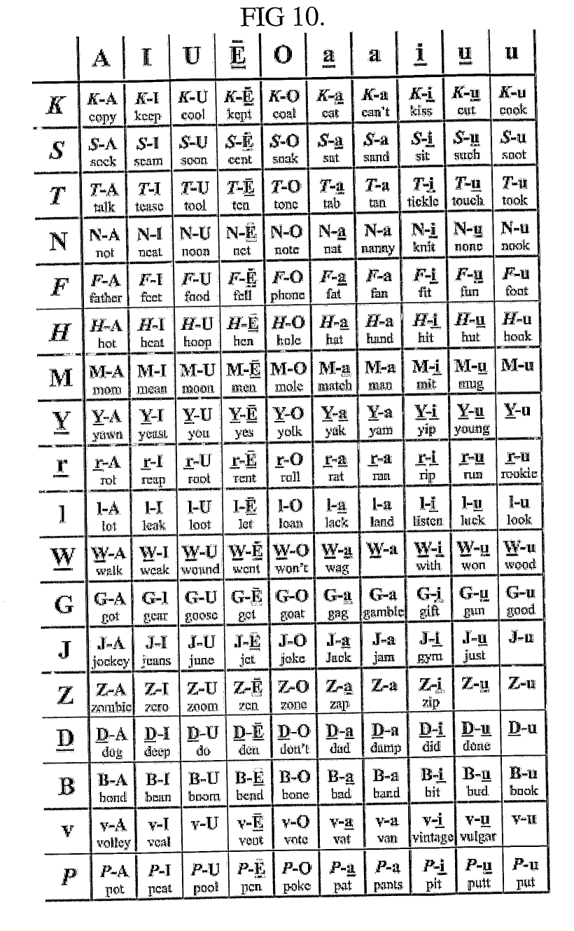

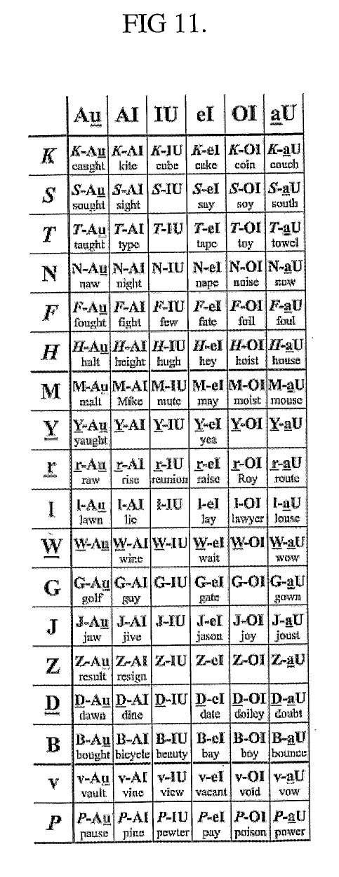

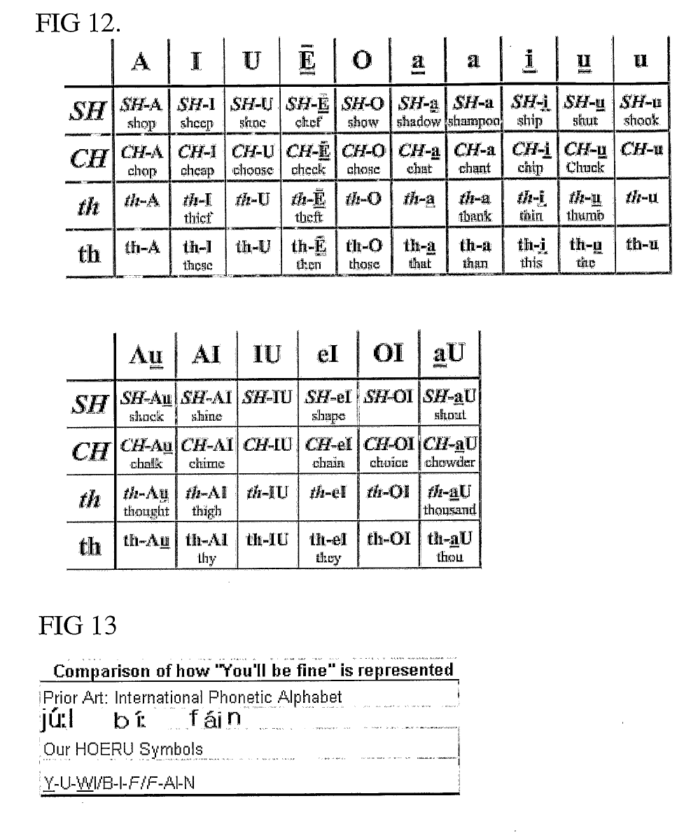

We add several more rules that we discovered. We now begin to use our pronunciation symbols summarized in FIGS. 10, 11, and 12, the details of which are discussed later.
3-beat rule 6 (W Rule). When a syllable ends with O, U, IU, or aU and a next syllable begins from a vowel, W emerges to make the transition smooth.

See some examples:

(1) You are Y-U-W/W-A-r
(2) going G-O-W/W-I-NG
(3) do it D-U-W/W-i-T
(4) How is . . . H-aU-W/W-i-Z
3-beat rule 7 (Y Rule). When a syllable ends with I (including OI, AI, and el) and a next syllable begins from a vowel, Y emerges to make the transition smooth.
   (1) Seeing S-I-Y/Y-I-NG
   (2) I am #-AI-Y/Y-a-M
   (3) try it Tr-AI-Y/Y-i-T

No current dictionary includes information about the W and Y rules, despite that these rules the way native speakers speak. The W rule and the Y rule may have to be reviewed and modified according to a specific language, as available vowels in a language may vary.

Finally, we note that sometimes at the beginning or at the end of utterances, it simply is not possible to have complete CVC patterns because a phrase begins with a vowel. For example, an example above “I am” begins from a vowel; hence, it simply is not possible to impose a CVC structure to it. This means that a word can being from a V (e.g., “if”) and it can end with a CV (e.g., “to”) or a C (e.g., people). Therefore:
3-beat rule 8 (Jagged Edge Rule). At the beginning or the end of a phrase, it is okay not to have a complete CVC structure. Still, the syllables that lack a complete CVC should be also read in the duration of one clap.

To summarize, our 3-beat theory has eight basic rules with which to predict how a native speaker of European languages read a phrase and sentences. We claim we were the first to discover these rules, except for the first rule about the CVC structure.

Our 3-beat principals can help eliminate wrong ideas that prior arts introduced. Philologists have created the notion of stress (or accent). They believed that when reading English or European languages there are locations in a word that have to be stressed strongly or weakly. Influenced by linguists, most dictionaries, including the Webster dictionary, shows where a primary stress and a secondary stress fall on a word. Japanese educators have bought into this and taught the stress position very enthusiastically in English curriculum. Even high school or college examinations ask a stress position of a word. For example, students are given a word “network,” and are asked whether “net” is stressed or “work” is stressed.”

When learners learn through our method (to be disclosed below), they can forget about the notion of stress position completely. Of course, we don't deny that stresses exist; however, if only learners resonate sounds in the two throat locations, their English will obtain a natural tone to it. This is because sounds resonated at the burp area tend to be lower in pitch, while the sounds resonated at the yawn area tend to be high in pitch. Thus, even without being aware of stress positions, learners will acquire very natural pitch in their English. Students who learn through our method will be forever liberated from the daunting and time-consuming task of memorizing stress positions of words.

### Invention

Based on these discoveries of natural phenomena occurring in the speech organs of European and Asian language speakers, we derived our invention with industrial utility. We present our invention first as a teaching method and second as a system of sound representation that can be used in an actual devise that help users with pronunciation.

### Our Invention as a Teaching Method

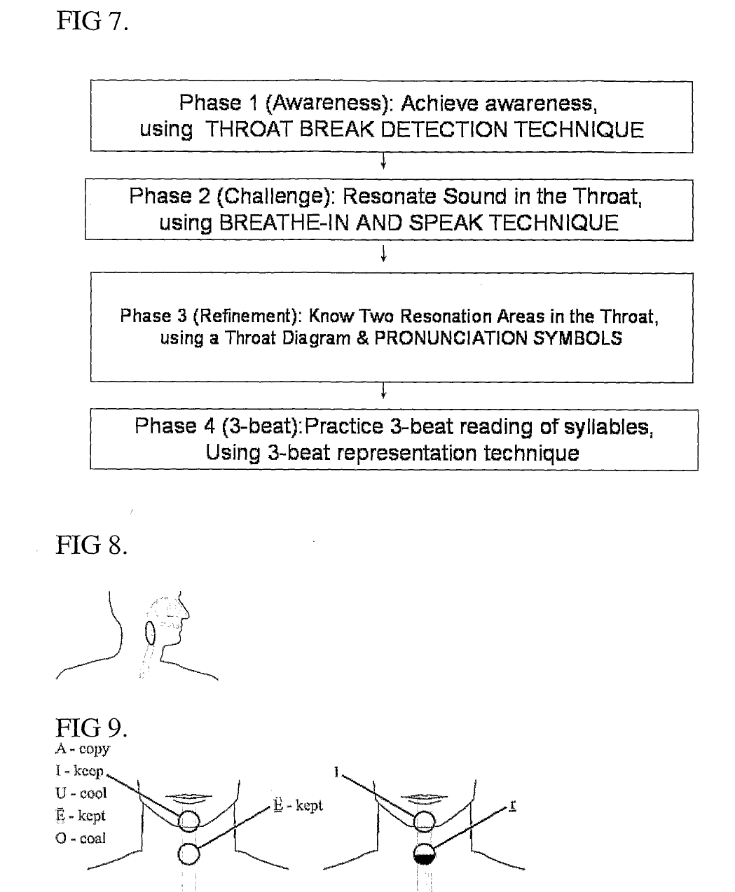

Speaking from the throat method, or HOERU (Howl) Method, includes four phases: Awareness, Challenge, Refinement, and 3-beat. FIG. 7 summarizes these phases:

### <FIG. 7>

In the first phase (Awareness), Asian learners must become aware of their unique use of their throat. Second (Challenge phase) they need to practice resonating sounds in the throat. Third (Refinement phase), they learn what part of the throat (yawn area or burp area) should be used to pronounce each individual sounds. Finally (3-beat) they must learn how to do 3-beat reading, using the HOERU symbols. In this final phase, learners will be given sentences to practice with. We describe each phase below.

### Phase 1 Awareness

In the awareness phase, learners develop awareness. Asian learners will recognize that their sounds resonate primarily in the mouth, while their throat tends to be tense while they are speaking. To achieve this awareness, learners study how they are pronouncing in their own language. Specifically, they need to be aware of “throat break” that allows them to produce choppy sounds in Asian language. FIG. 8 shows the area of the throat where throat breaks occur.

### <FIG. 8>

Throat break can take two forins. When Japanese are speaking at a normal speed, their throat stays tense to produce short sounds. This is one form of throat break, as the throat tenses and prevents resonation from happening in the throat. In extreme cases when they say individual sounds (e.g., A I U E O), Japanese even close their air path at the intersection of the back of the tongue and the back of the mouth roof, the blockage of air of which serves as a break of a sound. This is a strong throat break.

One way to notice the existence of throat break is to pay close to attention to the throat by speakers themselves. The other way to force learners to notice is to let them whisper sounds in their own languages. If they listen to their throat carefully, Japanese can notice that the back area of the throat is opening and closing, making a series of small noises. Because this noise is difficult to describe in writing, we placed our sound files in the following website.

<Sound file 1 The sound of throat break at http://www.estat.us/patent The password is hoerumethod.>

We are not yet sure if other language groups, other than Japanese, make this noise; however, speakers of non-European languages (e.g., Chinese and Korean) still tense their throat; thus, the learners should be repeatedly told to relax their throat; otherwise, deep resonation, necessary to imitate sounds, cannot be achieved.

We call our technique thought-break detection technique. To reiterate, for speakers whose throat makes a small noise when whispering (e.g., Japanese and most likely Koreans) can listen to the sounds. It helps to listen to the prerecorded tape because it is a subtle sound. For Asian speakers whose languages don't make this noise, they must instead pay close attention to their throat and notice the tension when making sounds.

In this phase, learners must understand that a) European language speakers keep their throat open while speaking, b) their throat is completely relaxed, and c) only with relaxed throat sounds can resonate deeply in the throat. Learners must also listen to sample sounds in their language and in European languages to hear the obvious difference in the location of resonation.

<Sound file 2 Comparison of mouth-resonated sounds and throat-resonated
sounds at http://www.estat.us/patent The password is hoerumethod.>

Once learners know this, they quickly learn why Asian sounds have rather a flat quality and European sounds are 3-dimentional qualities to them.

### The Second Phase

### Challenge

The second phase (Challenge) is to help learners to use the throat to resonate sounds, so they can easily imitate European sounds. They are asked to try something that is easy for Europeans but is difficult for Asians. They are asked to make simple sounds (e.g., A I U E O) while they breathe in.

For European language speakers, speaking while breathing in is not particularly difficult. There is even an expression in English (i.e., “gasp”) that is said while a speaker breathes in—to express a surprise. Breathing in and speaking at the same time is possible for European language speakers because their throat is always open, which makes it possible to breathe in even when one is speaking. The throat also stays relaxed, so resonation can occur.

This is very difficult for Japanese or other Asians. When they try to speak, their throat tenses and even closes in extreme cases. This gets in the way of a person trying to breathe in.

Although this exercise sounds difficult or even impossible for Asians, this is a mental exercise rather than a physical exercise. If they can convince themselves that it is okay to relax the throat and let it open even while speaking, they can easily make noise while breathing in. By attempting this, Asian learners can achieve both open and relaxed throat—because it is not possible to speak without open and relaxed throat. They begin to feel how the whole throat area can work like a long instrument that can resonate well. Once they know that the throat can be resonated while breathing in, they are told to breathe normally this time, and to continue practicing to speak from the throat.

We call this breath-in and speak technique. Learners must be careful not to hurt their throat. Their throat has to stay completely relaxed; otherwise, they hurt their throat. They must stop long time before they feel their throat begins to hurt. To repeat, they should know this is a mental exercise rather than a physical exercise. Any human being can breathe in and speak if they can relax their throat and keep it open when making sounds. An example sound file is available on the same website:

<Sound file 3 Example of Breath-in and speak exercises
at http://www.estat.us/patent The password is hoerumethod.>

### The Third Phase

### Refinement

The third phase (Refinement) is to refine sounds by knowing two locations in the throat that can be resonated. Europeans who are learning European languages that are not their native language also benefit from this phase. They already use their throat to speak their first language, but they only do so subconsciously and don't know how to use different resonation areas selectively for different European languages.

As we already mentioned, the yawn area is the area above the vocal cord and the burp area is the area below the vocal cord. We also mentioned that all sounds can be matched to either of these two areas as the area of resonation (Review FIG. 2). The location of throat resonation varies by languages. For example, most of French sounds come from the burp areas, while English use both rather evenly. This also depends on a regional variation of these European languages. For example, standard American English may use the yawn area for a vowel O, while standard British English uses the burp area for the equivalent sound.

In this phase when learners are introduced to the two areas of resonation in the throat, they are also introduced to our sound representation system, “HOERU (Howl) symbols.” In HOERU symbols, we use standard alphabets, but by using underline, italics, upper-case/lower-case letters, we differentiate sounds in terms of various qualities. Before discussing the details, we present some selective lists of sounds from Standard American English.

[symbol]

| | | | |
|---|---|---|---|
| A | copy | sock | talk |
| I | keep | seen | team |
| U | cool | soon | two |
| [symbol] | kept | cent | ten |
| O | cold | sold | told |
| i | if | kiss | ship |
| u | cut | up | of |

Consonants can be expressed in the same way.

| | | | | | | | | | |
|---|---|---|---|---|---|---|---|---|---|
| M | S | H | P | F | N | T | D | K | G |
| J | W | B | v | Y | Z | lr | SH | CH | th |
| th | zh | | | | | | | | |

These HOERU symbols can be mapped on the throat diagram. FIG. 9 shows two throat diagrams and indicate which part of the throat has to resonate for each individual sound. Learners should look at the HOERU symbol and the throat diagram, listen to the sample sounds, and practice to repeat the sounds.

### <FIG. 9>

FIGS. 10, 11, and 12 present HOERU symbols for Standard American English. These charts are based on our study of English spoken by news anchors in the US.

### <FIGS. 10, 11, and 12>

We review the rules that created these symbols. HOERU symbol Rule 1 (Underline and Upper Line Rule): For the sounds that resonate at the burp area, we underline the alphabets. For the yawn-area sounds, we do nothing, but if a user wishes to make it explicit, he/she can use an upper line to the alphabets. E (as in “kept”) is an exception in Standard American English. It can be resonated either at the yawn or the burp areas. We put both an underline and upperline to E.

HOERU symbol Rule 2 (Upper/Lower case Rule): When sounds exist also in Japanese, we used upper case letters. If they don't exist in Japanese, we used lower case letters. Obviously, this depends on a native language of learners. We recommend we adjust this, depending on the audience.

Notice that in the case of Japanese, a majority of sounds exist already in Japanese. Despite this, Japanese believed their sounds were completely different from English. In fact, a majority of sounds are identical if only resonated in the throat. Our symbols are revolutionary also in this sense—learners can pronounce most of the sounds confidently, knowing many sounds are identical in English and in their native language.

HOERU symbol Rule 3 (Italic Rule): If sounds are unvoiced sounds, we italicized the alphabets. Unvoiced sounds are the sounds that the vocal cord does not vibrate. One can tell this by touching the throat with a hand when pronouncing unvoiced sounds (e.g., F, T, S). Asians tend to produce these sounds in the mouth by producing strong fricative sounds or sounds of strong air; however, this is influenced by a mistaken advice of linguists who have classified these sounds in terms of what happens in the mouth. Learners must instead resonate these sounds in the throat. Instead of feeling a friction of air in the mouth, learners should be feeling a puffing effect in the throat, a sensation that accompanies a popping feeling either at the yawn area or at the burp area, depending on a sound resonation area.

In this refinement phases, learners should be shown these HOERU symbols and hear sample sounds. Being aware of which area of the throat to resonate, speakers can practice their pronunciation. As we discuss later as some embodiments of this invention, learners are shown the HOERU symbols on the screens of computers, portable music players (e.g., Apple's ipod), or designated portable devises.

The final phase, 3-beat, involves learners' getting used to reading syllables in the 3-beat way. We continue to use HOERU symbols, but discuss its capability to represent how native speakers read phrases as clusters of syllables. We start from examples to describe our system of representation for 3-beat, using HOERU symbols, so readers can have a sense of how they look like.

You'll be fine.
Y-U-Wl/B-I-F/F-AI-N
How are you feeling?
H-aU-W/W-A-r/Y-U-F/F-I-l/l-I-NG
What do you eat for breakfast in America?
W-u-T/D-U-Y/Y-U-W/W-I-T/F-O-r/Br-\tilde{E}-K/F-i-ST/ST-i-N/
N-u-M/M-eI-r/r-i-K/K-u-#
You'll be fine.
Y-U-Wl/B-I-F/F-AI-N

Earlier in the description of our discovery, we detailed the eight rules of 3-beat. Here, we show how those rules are now represented by the HOERU symbols.

3-beat rule 1 (CVC Rule): A basic sound unit in European languages is a syllable made up of C-V-C. This unit has to be read in the duration of one clap.

We incorporate this rule by putting C, V, C together with dashes in between them. We also separate syllables by slashes. See how dashes and slashes are used in an example, Y-U-Wl/B-I-F/F-AI-N (You'll be fine.)”

3-beat rule 2 (Group Rule): group consonants or group vowels should be treated as, respectively, one C and one V. In the HOERU symbols, we place two vowels together in the place of one vowel. For example, “fine” is represented as “F-AI-N.” Notice AI is NOT separated by a dash.

3-beat rule 3 (Swing and follow-through Rule). A swing consonant is read up to a half of the sound and a follow-through consonant is read from a half point to the end.

Reader can tell the location of swing and follow-through consonants by how each consonant is situated in relation to slashes that separate syllables.

3-beat rule 4 (Copy Rule). When consonants are lacking to have complete CVC structures, consonants get copied from the next consonant.

When a consonant is missing, we copy a consonant from a space next to it. For example, in H-aU-W/W-A-r/(How are . . . ), W is copied from the first syllable to the second.

3-beat rule 5 (Phrase Rule). 3-beat applies not only to a word but also to phrases and sentences.

This is implemented as the rule says. To read a sentence like a native speaker would read, a learner should treat a sentence like a cluster of syllables rather than of words.

3-beat rule 6 (W Rule). When a syllable ends with O, U, IU, or aU and a next syllable begins from a vowel, W emerges to make the transition smooth.

This is implemented as the rule says. G-O-W/W-I-NG (“going”) is an example.

3-beat rule 7 (Y Rule). When a syllable ends with I (including OI, AI, and el) and a next syllable begins from a vowel, Y emerges to make the transition smooth.

This is implemented as the rule says. M-I-Y/T-U-# (“Me, too.”) is an example.

3-beat rule 8 (Jagged Edge Rule). At the beginning or the end of a phrase, it is okay not to have a complete CVC structure. Still, the syllables that lack a complete CVC should be also read in the duration of one clap.

This is noted with a symbol #. As an example, see the ending of the third example sentence above ( . . . N-u-M/M-eI-r/r-i-K/K-u-#).

Using the HOERU symbols designed based on these rules, we are able to express true sounds of European languages correctly and accurately. FIG. 6 compares how a prior art and our method represents the sound of an expression, “How are you?” If a learners follow the prior art, he/she would sound like a robot as they would ignore the 3-beat rhythm of European sounds. Our HOERU symbols reflects the true rhythm of English and can communicate the quality of sounds better with various notations. Such notations (e.g., italic, underline, etc.) are easily available in a standard word editor, like Microsoft WORD.

Learners must internalize these rules and practice reading phrases and sentences using them. What is important is to read a syllable in the duration of one clap and read a syllable to a syllable smoothly. If reading smoothly, speakers will know that the rule 3 (Swing and Follow through Rule) will be happening naturally, i.e., the swing is read up to a mid-point of the sound and the follow-through is read from the midpoint of the sound to the end.

To show how all of these rules work together, we present how one passage would translate phonetically with our new HOERU symbols: “Bento box lunches are special to Japan. A bento is a lunch that has many dishes. The most typical bento has fish, other meats, rice, pickles, and different kinds of vegetable dishes. Some kids take them to school. Some people take them to work for lunch. People love them. Some busy people buy them at convenient stores and eat them for dinner. You can even buy a bento before taking a train trip.”

B-\tilde{E}-NT/T-O-#/B-A-KS/l-u-N/CH-i-Z/Z-A-r/SP-\tilde{E}-SH/SH-u-l/T-U-#/
J-u-P/P-a-N
#-u-B/B-\tilde{E}-NT/T-O-W/W-i-Z/Z-u-l/l-u-NCH/th-a-T/H-a-Z/
M-\tilde{E}-N/N-I-Y/D-i-SHISH-i-Z
th-u-M/M-O-ST/T-i-P/P-i-K/Kl#-#/B-\tilde{E}-NT/T-O-#/H-a-Z/F-i-SH
#-u-th/th-E-r/M-I-TS
r-AI-S
P-i-K/KlZ-#-#/Z-a-ND/D-i-F/Fr-i-NT/K-AI-NDZ/Z-u-v/v-\tilde{E}-CH/T-u-B/
B-u-l/D-i-SH/SH-i-Z
S-u-M/K-i-DZ/T-eI-K/th-\tilde{E}-M/T-U-S/SK-U-l
S-u-M/P-I-P/Pl-#-#/T-eI-K/th-\tilde{E}-M/T-U-W/W-E-rK/F-O-r/l-u-NCH
P-I-P/Pl-#-#/l-u-v/th-\tilde{E}-M
S-u-M/B-i-Z/Z-I-Y/P-I-P/Pl-#-#/B-AI-Y/th-\tilde{E}-M/M-a-T/
K-u-N/v-I-N/Y-i-NT/ST-O-rZ/Z-a-ND/D-I-T/th-\tilde{E}-M/F-O-r/D-i-N/N-E-r
Y-U-K/K-a-N/N-I-v/v-i-N/B-AI-Y/Y-u-B/B-\tilde{E}-NT/T-O-#/B-I-F/F-O-r/
T-eI-K/K-I-NG/#-u-T/Tr-eI-N/Tr-i-P

Throughout all these phases, learners will be given abundant audio and visual information. Computers or small-size gadgets with screens (e.g., electronic dictionary) can carry such information. Learners should listen to the sounds recorded and repeat while looking at the pronunciation symbols shown on the screen. For the awareness phase, when learners become aware of differences of Asian and European sounds and practice to make a transition from mouth pronunciation to throat pronunciation, learners will benefit greatly by listening to sounds of the same word said in Asian way (by mouth resonation) and in European way (by throat resonation). The learners will notice the obvious sound quality difference between their own language and European sounds—the difference they might have wrongly attributed in the past to the biological differences between Europeans and Asians.

Learners must master each phase well before moving on to a next phase. Without having an awareness of how Asians tense their throat and Europeans relax their throat (Awareness phase), learners won't succeed at practicing the use of the throat. Without not being able to resonate sounds in the throat (Challenge phase), they will not succeed at using the two throat resonation areas (Refinement phase). European learners can start from phrase 3 since they already use the throat to speak their native languages.

Without knowing all the prior steps, Asian speakers will not be successful with 3-beat reading. This is particularly important for Japanese learners. As long as resonating in the mouth, Japanese cannot say consonants independently (Review FIG. 3). For example, they tend to say ho-to instead of hot as they cannot say an independent consonant T. However, if they learn to resonate in the throat, they become able to produce any sounds independently. This finally allows Japanese to say each individual sound separately, put together the sounds correctly, and read syllables using the 3-beat principle. To master 3-beat reading, learners must be given many example exercises, so they can internalize the way native speakers of European languages read and speak.

We recommend completing the four phases in one month. The awareness phase and the challenge phase can occur very quickly if learners feel they mastered these steps. The refinement phase may take a few weeks since learners must learn about many sounds that exist in a target language. For understanding the content of 3-beat may take also a few weeks. After completing a course, it is recommended that students continue practicing little by little, so their English gets closer and closer to native-like English. However, little bit of accent, however, doesn't become a communication problem as long as a learner pronounces in the throat and read sentences in 3-beat.

### Our Invention Materialized Explicitly as a Reading Assistance Device

We now describe the part of the invention that can be described not only as a system of concepts and practices, but also as a useful system to create an actual device. The devise may be called reading assistance device, electronic dictionary, or pronunciation machine. Such an apparatus have memories loaded with vocabularies, sounds, and the programmed functions that process information based on the rules of the Hoeru symbols and 3-beat reading.

For simplicity, we call these embodiments “the reading assistence devise” or simply “the devise.” The devise can exist as software (to be used on computers), a downloadable data that can be read by a portable music players (e.g., Apple's iPod), or an independent gadget with audio, visual, and recording functions. In today's age of the internet, the program can be also written on the internet-based applications. Among all, we consider an electronic portable machine as a preferred medium.

The reading assistance devise can function as an electronic dictionary. A user types in a word and phrases and the software/machine returns a response by showing a word, its meaning, its phonetic representation using our new system, and a pre-recorded sound. We can also have expression lists selected for teaching purposes. Sounds are pre-recorded and the Hoeru symbols are already assigned to words and phrases. For example, an expression like “What time is it?” is played according to a user's request, while a user reads the HOERU symbols to know correct way of reading the expression.

The devise accompanies “the word and sound bank.” The bank stores digital information about words written in ordinary spelling (e.g., how), as well as in the HOERU symbols (e.g., H-aU-W, and sounds associated with words (recorded by narrators). The bank also stores sounds of individual sounds and halves of the sounds. The halves of the sounds mean the first half and latter half of the sounds, which will be used to fulfill the swing and follow-through rule. We use all the rules we discussed so far to organize information in this word and sound bank.

We note that individual sounds (e.g., A, M, F, etc.) that are stored in the bank have certain pitch to them. The sounds that resonate at the burp are naturally lower in pitch than the sounds that resonate at the yawn. In the theoretical description of our discovery, we discussed as a phenomenon that occurs without speakers' thinking. Thus, when the devise produces sounds based on the individual sounds put together (as opposed to prerecorded reading of words by a person), the tone of it will be more natural and human-like than already existing products.

### Interactive Mode 1

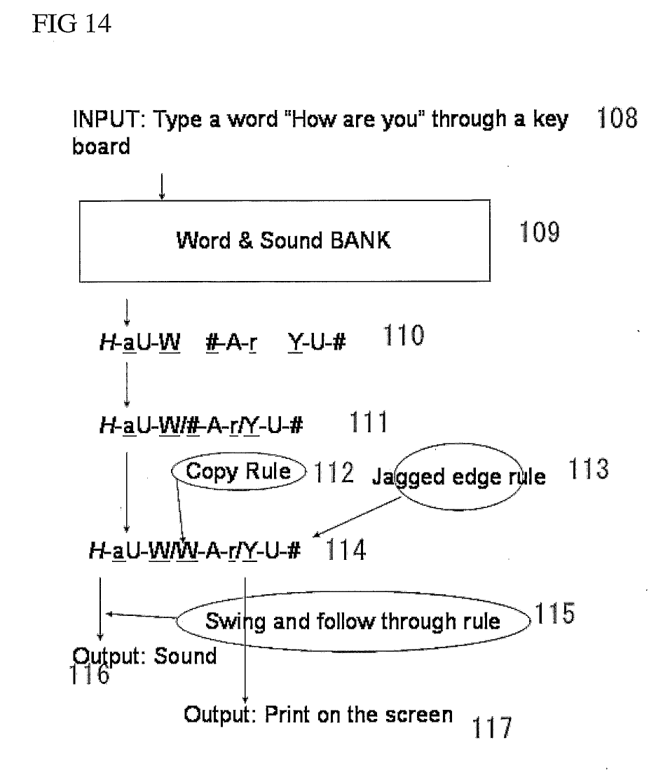

We elaborate the interactive mode of showing how to read words, phrases, and sentences. FIG. 14 explains one sample process.

### <FIG. 14>

A user uses a keyboard and types in an expression, “How are you? (#108)” This information is sent to the word and sound bank (#109), which is part of a computer program. It selects the words expressed in the HOERU symbols with an output:

H-aU-W #-A-r Y-U-#. (#110)

Now the devise then put together the HOERU symbols as one sentence (#111):

H-aU-W/#-A-r/Y-U-#.

The devise now applies some relevant rules to create a final sentence. In this example, the copy rule (#112) and jagged edge rule (#113) are applied, which is how original words “How are you?” gets converted finally into:

H-aU-W/W-A-r/Y-U-#. (#114)

Using the sounds prerecorded and associated with the three words and using the swing and follow through Rule to read the connection between the words smoothly (#115), the devise reads the sentence with a native-like flow (#116). The sentence written in the HOERU symbols are also printed on the screen (#117), so the user can see.

### Interactive Mode 2

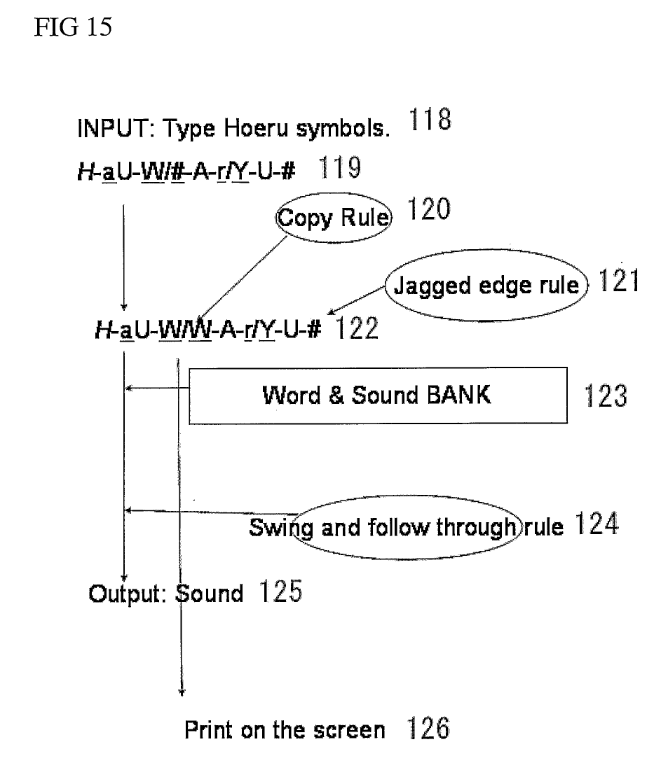

FIG. 15 explains another scenario. In this case, a user types the HOERU symbols directly through a keyboard (#118).

H-aU-W #-A-r Y-U-#. (#119)

The devise put together the words together, applying the HOERU rules (the copy rule [#120] and the jagged edge rule [#121]) to finalize it as a sentence to be read:

H-aU-W/W-A-r/Y-U-#. (#122)

Using the sounds and half sounds from the sound and word bank (#123) based on the swing and follow-through rule (#124), the devise reads the sentence (#125).

The 3-beat rules that we identified using Standard American English are very accurate and many of those rules apply to most European languages. However, we acknowledge the possibility that exceptions can occur. This is because a language is spoken by human beings and exceptions do occur with human phenomena. When using the devise in this advanced mode, users must be aware that the dictionary could return wrong connections.

### Alternative Modes of Our Invention

Our teaching technique should be used more generally as a way to introduce English to students. Japanese students learn English first by memorizing regular spelling and associate it to pronunciation; however, this is the opposite of how children learn a first language. They learn sounds first as small children and typically about six or seven years later they begin learning how to spell and how to read. Non-native speakers of European language can follow the same order. They should first learn languages as sounds. They should learn grammar, vocabulary, and conversation using primarily sounds and treating regular spelling as secondary. The HOERU symbols serve a good purpose for describing the sounds students should learn.

There are many Westerners who can speak Asian languages well, but they cannot read or write as much, which proves that reading and writing can be separate issues from learning to communicate verbally. Typically Asian people are not enthusiastic about this type of communication-driven approach; however, we believe it is even better to learn to communicate primarily based on sounds before learning of writing and reading occurs. Student will have a solid skill to use the language before tackling a difficult task of writing and reading in the new language. In this type of project, our invention will be very useful.

Our idea of reading assistance devise can be applied to any type of prerecorded announcement. Computer generated voice that is available today is very mechanical. For example, a recording that we get on business phone calls (e.g., airline ticket reservation) reads numbers in a very robotic way. Using our system of HOERU symbols and prerecorded sounds that match the specification of the HOERU rules we identified, we can produce a more seamless natural human voice.

Our representation method can be applied to a Karaoke sing-along machine. Popular in many parts of the world, particularly, in Japan and Korea, Karaoke plays music of popular songs, so people can enjoy adding their vocals. As it is very popular to sing Western songs in these countries, our representation method can be added to the screen as subtitles, in addition to the lyrics written in traditional way.

One caution is due. When westerners sing, they may sing differently from the way they speak. In particular, resonation area changes; therefore, the notation that expresses this has to be modified according to the way the songs are actually sung. However, 3-beat way of reading stays for the most part the same (in English regardless of the different spoken accents) with singing; thus, Asian people who enjoy singing in English will greatly benefit from this embodiment of our invention.

### INDUSTRIAL APPLICABILITY

Industrial applicability of our invention is immense and even revolutionary in light of communication history between West and East. At the time of this writing, the world is already said to be “smaller” as a result of rapid advancement of communication technology, allowing a global economy to form. Yet, people living in Asia still face cultural barriers in their communication with the West. They experience communication problems because of their accent and partly because of that they have listening comprehension problem

Our invention solves all these problems by providing a better means of teaching pronunciation and listening comprehension of English, as well as other European languages, that allows the production of textbooks and instruction plans. Individuals are enriched by our method and teachers/schools benefit by providing the pedagogy that works. Furthermore, industrial products such as digital dictionaries/pronunciation devises that will assist Asian learners to read English correctly with native-like flow.

In summary, we, inventors, believe that our invention will find a large number of industrial application, which will have a serious consequence to the communication history of the Asian world and the European world. As a result of improved communication, the world will be even smaller than before.

1. A method of teaching pronunciation/listening comprehension of European languages, comprising:
(a) promoting awareness of how learners' use of the throat is different from native speakers' use, using throat break detection technique
(b) resonating sounds in the throat, using breathing-in and speak technique
(c) knowing two resonation areas of the throat, using a throat diagram and our new system of representing European sounds
(d) practicing 3-beat reading of syllables using 3-beat representation technique

2. A system of representing European sounds with standard alphabets, comprising:
a. the use of some properties of alphabet fonts, such as upper line and underline, to indicate, respectively, the resonation at the yawn area and that at the burp area (discussed as Underline and Upper Line Rule in the description)
b. the use of some properties of alphabet fonts, such as upper-case and lower case, to indicate, respectively, the sounds that exist in the first language of the learners and those that don't exist in the language (discussed as Upper/Lower case Rule in the description)
c. the use of some property of alphabet fonts, such as italics, to indicate the sounds that are unvoiced consonants (discussed as Italic Rule in the description)
d. the CVC rule and the Phrase rule (combined) to divide up words and phrases into groups of consonant-vowel-consonant and read each one in the duration of clap
e. the group rule to treat group vowels as one vowel to create a consonant-vowel-consonant structure and to read them smoothly as if they were one vowel sound
f. the group rule to treat group consonants as one consonant to create a consonant-vowel-consonant structure and to read it them smoothly as if they were one consonant sound
g. the swing and follow-through rule to read a swing consonant (as defined in the description) to the middle of the sound and to read a follow-through consonant (as defined in the description) to read from the middle of the sound to the end.
h. the copy rule to copy a consonant from the closest consonant when the spot for a consonant in the syllable structure is empty
i. the W rule to use a W sound to connect a syllable that ends with O, U, IU, or aU and a syllable that starts with a vowel.
j. the Y rule to use a Y sound to connect a syllable that ends with I (including OI, AI, and el) and a syllable that starts with a vowel.
k. the jagged edge rule to allow the empty spot at the beginning or the end of a phrase where there is no consonant that can be copied.

3. An electronic device that converts words and phrases into HOERU symbols and read them with native-like flow, comprising
a. a keyboard that allows a user to enter words and phrases
b. the word and sound bank that stores words, the words expressed in our new symbols, and prerecorded sounds
c. the computational process that applies the CVC rule, Group Rule, Swing and follow-through Rule, Copy Rule, the Phrase rule, W Rule, Y rule, and Jagged Edge Rule (all defined in the description), to a phrase that a user has input.
d. the computational process that print outs the result in our new symbol with the rules applied to have connected syllables and to read the phrase with prerecorded sounds.
